(19) United States
(12) Patent Application Publication
(10) Pub. No.: US 2008/0273109 A1
(43) Pub. Date: Nov. 6, 2008

(54) PORTABLE DEVICE WITH INTERACTIVE DISPLAY AND GEOGRAPHICAL LOCATION CAPABILITY

(76) Inventor: Drew Bamford, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 11/967,284

(22) Filed: Dec. 31, 2007

Related U.S. Application Data
(60) Provisional application No. 60/915,437, filed on May 2, 2007.

(51) Int. Cl. H04N 5/222

(52) U.S. Cl. 348/333.02; 348/E05.022

(57) ABSTRACT

A portable device having geographical location technology includes: a camera, for capturing an image; a wireless access circuit for accessing a geographical database to generate information according to the geographical location technology of the portable device; a display screen, for displaying at least the image and the generated information, the display screen comprising: a location bar, comprising at least one location point, each location point corresponding to at least one point of interest in a displayed image; and a processing circuit, coupled to the camera, the wireless access circuit, and the display screen, for controlling operations of the camera, the wireless access circuit, and the display screen.

### CROSS REFERENCE TO RELATED APPLICATIONS

This application claims the benefit of U.S. Provisional Patent Application Ser. No. 60/915,437 filed on May 2, 2007.

### BACKGROUND OF THE INVENTION

1. Field of the Invention

The present invention relates to a portable device with geographical location capability, and more particularly, to a portable device that can utilize location images and the geographical location capability to generate information pertaining to said location image in an interactive way.

2. Description of the Prior Art

Geographical location technology such as the well-known Global Positioning System (GPS) has been utilized to wide effect, having a significant impact on everyday activities such as driving. This technology is now being utilized in innovative ways, such as combining the technology in portable/handheld devices to enable tourists to accurately pinpoint their location when traveling in unfamiliar areas by foot.

Recent innovations such as wireless communication have also had a significant impact on tourists, by allowing them to access information relating to a particular geographical location or historic site and download that information to a portable device such as a smart phone or PDA. Digital technology enables multimedia information to be downloaded to these portable devices.

The present invention aims to expand on these developments, by combining geographical location capability, digital technology, and wireless communication with an interactive interface that allows a user to capture an image, select objects from the image, and download information relating to the selected object.

### SUMMARY OF THE INVENTION

With this in mind, an embodiment of a portable device and a related method are disclosed, for providing technology that can enable the above-mentioned operation.

A portable device having geographical location technology according to an exemplary embodiment of the present invention comprises: a camera, for capturing an image; a wireless access circuit for accessing a geographical database to generate information according to the geographical location technology of the portable device; a display screen, for displaying at least the image and the generated information, the display screen comprising: a location bar, comprising at least one location point, each location point corresponding to at least one point of interest in a displayed image; and a processing circuit, coupled to the camera, the wireless access circuit, and the display screen, for controlling operations of the camera, the wireless access circuit, and the display screen.

A method for displaying information related to an image on a portable device comprises: activating geographical location technology to determine a current location of the portable device; utilizing the portable device to capture an image; utilizing a wireless capability to access a geographical database for generating information according to the image and the geographical location of the portable device; and displaying at least the image and the generated information including a location bar, comprising a plurality of location points, each location point corresponding to a point of interest in the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing the operating system of a portable device comprising a display screen for generating multimedia data according to an image.

FIG. 2 is a flowchart detailing the operation of the portable device shown in FIG. 1.

### DETAILED DESCRIPTION

As mentioned above, it is an aim of the present invention to provide an interactive display that enables a user to select information from a number of sources. This will be of particular use to travelers who wish to walk around an area of interest such as a large city, while continually accessing information relating to their location.

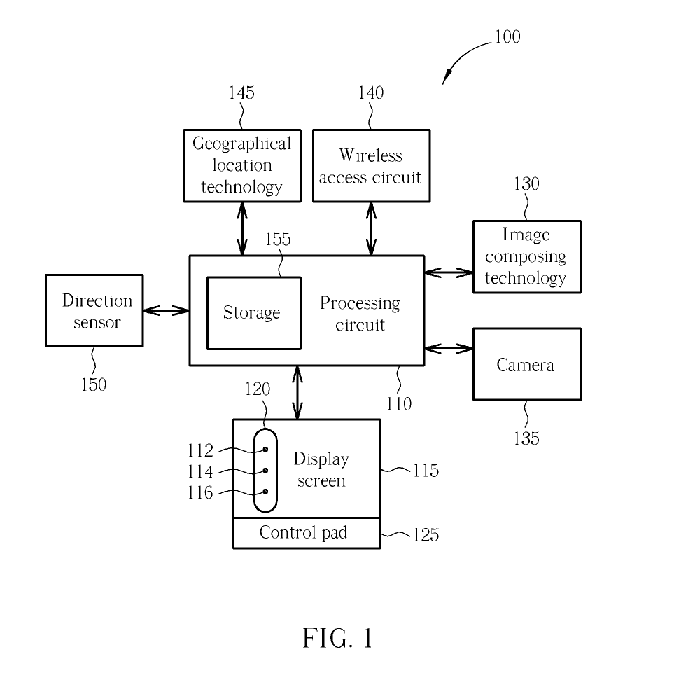

Please refer to FIG. 1. FIG. 1 is a diagram of a portable device 100 according to an exemplary embodiment of the present invention. The portable device 100 may be a smart phone, a pocket personal computer (pc)/pc phone, a GPS receiver, or other location sensing device that has a camera. The portable device 100 comprises a camera 135 and a display screen 115 for displaying images captured by the camera 135 and further comprising a location bar 120. In the diagram the location bar 120 is shown as comprising three location points 112, 114, 116 corresponding to three respective points of interest in an image captured by the camera 135. The portable device 100 also comprises a wireless access circuit 140, for accessing Internet sites such as geographical databases, geographical location technology 145, for determining a location of the portable device at any point in time, and a direction sensor 150, for determining movement of the portable device 100. A processing circuit 110 is utilized for synchronizing operations of all the separate blocks and comprises a storage 155 that can save downloaded or generated information relating to the portable device 100. The display screen 115 can be a touch screen or can optionally comprise a pointing device 125 such as a control pad, mouse, toggle switch, and navigation key etc. for navigating the display screen 115. The geographical location technology 145 can be Global Navigation Satellite System (GNSS) Global Positioning System (GPS), or similar technologies with location sensing capability. The portable device 100 also comprises image composing technology 130 for performing image rendering.

The display screen 115 is an interface for displaying multimedia information—in particular, for displaying an image captured by the camera 135 and written information downloaded utilizing the wireless access circuit 140. In a PDA phone the display screen 115 is a touch screen, but any interface that allows a user to select certain areas of the captured image (such as a mouse, for example) also falls within the scope of the present invention.

The use of the portable device 100 will now be described in a situation where a user wishes to walk towards a particular object of interest, for example a famous building. In the following description it is assumed that the geographical location technology 145 is GPS. The user utilizes the camera 135 to take a photograph of a panorama, and the image composing technology 130 then generates a digital image to the display screen 115. The GPS 145 is then activated for determining the location of the portable device 100. The user can manually activate the GPS 145 or the capturing of the image can automatically activate the GPS 145. The portable device 100 then utilizes the determined location and the wireless access circuit 140 to access a geographical database for searching for an image that corresponds to the image on the display screen 115.

Once a match for the image is obtained, objects in the image can be identified and multimedia information relating to said objects are downloaded to the storage 155 and then accessed by the user. The display screen 115 of the present invention comprises a location bar (slider) 120 at one side of the display screen 115, having a plurality of location points 112, 114, 116 as shown in FIG. 1, each corresponding to an object of interest in the image. The location bar 120 can then be utilized to select a specific object of interest from among the plurality of objects. Once a specific object of interest is selected, the wireless access technology 140 of the portable device 100 can be utilized to download relevant multimedia information, for example, maps showing how to reach the object, historical information, photographs etc, or information that has already been downloaded can be accessed directly from the storage 155. Another object of interest can then be selected though the utilization of the location bar 120.

If the user decides to walk towards a certain object of interest, the portable device 100 can still be utilized. The GPS 145 remains activated, so a location of the portable device 100 can be continuously tracked. If the user wishes to continue to utilize the display screen 115 for accessing information while changing an angle of view (in other words the geographical location of the portable device 100 may be the same but the view seen by the user is shifted by a certain angle or elevation), the portable device 100 can continuously render current images to the display screen 115 through the use of the direction sensor 150 that detects a movement of the portable device 100 both vertically and horizontally. This detected movement can then be utilized in conjunction with a geographical database and the image composing technology 130 to render an image to the display screen 115 corresponding to the view as seen by the user.

The location of the location points 112, 114, 116 on the location bar 120 correspond to a distance of each respective point of interest from the user. This information is generated according to the GPS and through the wireless access circuit 140. The location bar 120 is therefore a simple and efficient way of accessing information about all points of interest in the image. If two points of interest are at a same distance from the user's position they will appear in the same place on the location bar 120. This can be represented by a location point that is a different brightness than the other location points or is a different color.

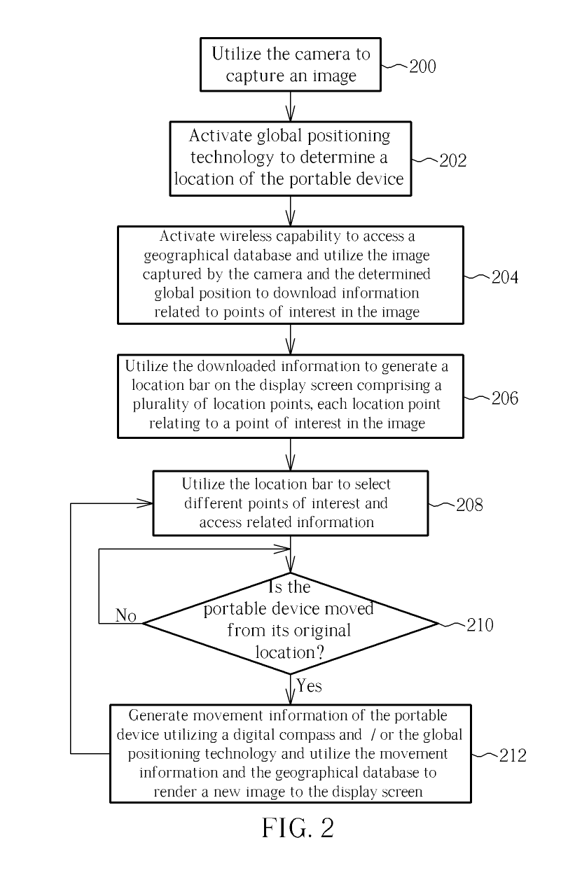

Please refer to FIG. 2 which is a flowchart detailing the operating stages of the portable device 100 of FIG. 1. The steps are as follows:

Step 200: Utilize the camera 135 to capture an image;

Step 202: Activate global positioning technology 145 to determine a location of the portable device 100;

Step 204: Activate wireless access circuit 140 to access a geographical database and utilize the image captured by the camera 135 and the determined global position to download information related to points of interest in the image;

Step 206: Utilize the downloaded information to generate a location bar 120 on the display screen 115 comprising a plurality of location points, each location point relating to a point of interest in the image;

Step 208: Utilize the location bar 120 to select different points of interest and access related information;

Step 210: Is the portable device 100 moved from its original location? If yes go to Step 212; if no go back to Step 208;

Step 212: Generate movement information of the portable device 100 utilizing a direction sensor 150 and/or the global positioning technology 145 and utilize the movement information and the geographical database to render a new image to the display screen 115. Go back to Step 208.

The use of the direction sensor 150 and the image composing technology 130 allows an image to constantly be generated to the display screen 115 that corresponds with what the user sees. Therefore, at any point in time of using the portable device 100, the user can accurately know their distance from a particular point of interest and generate related information accordingly. The location bar 120 comprising a plurality of location points is a fast and efficient way of quickly accessing information corresponding to a plurality of points of interest in an image, as well as a novel way of directly displaying certain information corresponding to those points of interest (such as distance from the user) on the display screen 115.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable device having geographical location technology, comprising:
a camera, for capturing an image;
a wireless access circuit for accessing a geographical database to generate information according to the geographical location technology of the portable device;
a display screen, for displaying at least the image and the generated information, the display screen comprising:
a location bar, comprising at least one location point, each location point corresponding to at least one point of interest in a displayed image; and
a processing circuit, coupled to the camera, the wireless access circuit, and the display screen, for controlling operations of the camera, the wireless access circuit, and the display screen.

2. The portable device of claim 1, further comprising:
image composing technology, for composing the generated information and at least the image captured by the camera to render the displayed image.

3. The portable device of claim 2, wherein the geographical location technology is a location sensing system, and the composing technology generates the location bar in the displayed image according to co-ordinates generated by the location sensing system.

4. The portable device of claim 2, further comprising:
a direction sensor, for detecting rotation of the portable device;
wherein the wireless access circuit accesses the geographical database to generate information according to the detected rotation of the portable device, and the image composing technology generates the displayed image to the display screen according to the generated information and the detected rotation of the portable device.

5. The portable device of claim 1, wherein the location bar measures distance, and the at least one location point is arranged on the location bar according to a distance which a corresponding point of interest is from the portable device.

6. The portable device of claim 5, wherein when a first location point corresponds to a single point of interest, the first location point has a first brightness, and when a second location point corresponds to a plurality of points of interest, the second location point has a second brightness different from the first brightness.

7. The portable device of claim 5, wherein when a first location point corresponds to a single point of interest, the first location point has a first color, and when a second location point corresponds to a plurality of points of interest, the second location point has a second color different from the first color.

8. The portable device of claim 5, wherein when a specific location point is selected by a user, the display screen displays information corresponding to a specific point of interest specified by the specific location point.

9. The portable device of claim 8, wherein the information is multimedia information.

10. The portable device of claim 8, wherein the display screen is a touch screen for selecting the specific location point.

11. The portable device of claim 8, further comprising a pointing device for selecting the location points.

12. The portable device of claim 1 being a smart phone, pocket pc, pocket pc phone or location sensing device.

13. A method for displaying an image and information related to the image on a portable device, comprising:
activating geographical location technology to determine a current location of the portable device;
utilizing the portable device to capture an image;
utilizing a wireless capability to access a geographical database for generating information according to the image and the geographical location of the portable device; and
displaying at least the image and the generated information including a location bar, comprising a plurality of location points, each location point corresponding to a point of interest in the image.

14. The method of claim 13, wherein the step of displaying the image comprises composing at least the captured image and the generated information to render the displayed image.

15. The method of claim 14, wherein the geographical location technology is a location sensing system, and the step of composing at least the captured image and the generated information further comprises:
generating the location bar in the displayed image according to co-ordinates generated by the location sensing system.

16. The method of claim 14, further comprising:
detecting rotation of the portable device;
accessing the geographical database to generate information according to the detected rotation of the portable device; and
generating the displayed image according to the generated information and the detected rotation of the portable device.

17. The method of claim 13, wherein the location bar measures distance, and the at least one location point is arranged on the location bar according to a distance which a corresponding point of interest is from the portable device.

18. The method of claim 17, wherein when a first location point corresponds to a single point of interest, the first location point has a first brightness, and when a second location point corresponds to a plurality of points of interest, the second location point has a second brightness different from the first brightness.

19. The method of claim 17, wherein when a first location point corresponds to a single point of interest, the first location point has a first color, and when a second location point corresponds to a plurality of points of interest, the second location point has a second color different from the first color.

20. The method of claim 18, further comprising:
selecting a specific location point; and
displaying information corresponding to a specific point of interest specified by the specific location point.

21. The method of claim 20, wherein the information is multimedia information.
